(19) United States
(12) Patent Application Publication
(10) Pub. No.: US 2025/0046555 A1
(43) Pub. Date: Feb. 6, 2025

(54) ELECTROMAGNETIC RELAY

(71) Applicant: OMRON Corporation, Kyoto-shi (JP)

(72) Inventors: Hideto YAMAUCHI, Kyoto-shi (JP); Kazuhiro TSUTSUI, Kyoto-shi (JP); Hiroki KAWARASAKI, Kyoto-shi (JP)

(21) Appl. No.: 18/764,387

(22) Filed: Jul. 5, 2024

(30) Foreign Application Priority Data
Jul. 31, 2023 (JP) 2023-124686

(51) Int. Cl. H01H 50/44; H01H 50/54

(52) U.S. Cl. CPC H01H 50/44; H01H 50/54

(57) ABSTRACT

An electromagnetic relay includes a coil, a first contact terminal, a second contact terminal, a coil terminal, and a spool. The first contact terminal is disposed in front of the coil. The second contact terminal is disposed behind the coil. The coil terminal includes a body portion and a tie-down portion. The body portion is disposed between the first contact terminal and the second contact terminal. The tie-down portion extends forward from the body portion along the coil. The spool is disposed between the first contact terminal and the second contact terminal. The spool includes a front flange and a rear flange. The front flange includes a vertical wall portion and a lateral wall portion. The vertical wall portion is located between the first contact terminal and the tie-down portion. The lateral wall portion is bent relative to the vertical wall portion and extends forward from the vertical wall portion.

### CROSS-REFERENCE TO RELATED APPLICATION

This application claims priority to Japanese Patent Application No. 2023-124686, filed Jul. 31, 2023. The contents of that application are incorporated by reference herein in their entirety.

### FIELD

The present invention relates to an electromagnetic relay.

### BACKGROUND

Some electromagnetic relays have a pair of contact terminals disposed on both ends of a spool around which a coil is wound. In such electromagnetic relays, it is difficult to dispose the coil terminals on either end of the spool. Therefore, the coil terminal is disposed between both ends of the spool (see, for example, Japanese Patent No. 6344282).

The coil terminal includes a body portion and a tie-down portion. The body portion protrudes to the exterior of the electromagnetic relay. The tie-down portion protrudes from the body portion, and an end of the coil is wound around the tie-down portion to secure and electrically connect the end of the coil to the coil terminal. In order to compactly arrange the coil terminal together with the coil, it is desirable for the tie-down portion to be arranged along the coil. In this case, however, in the electromagnetic relay as described above, the tie-down portion is disposed so as to extend from the body portion toward the contact terminal. This shortens the distance between the coil terminal and the contact terminal, thereby reducing the insulation between the coil terminal and the contact terminal. An object of the present invention is to provide an electromagnetic relay in which a coil terminal is arranged compactly and insulation between a contact terminal and the coil terminal is improved.

### SUMMARY

An electromagnetic relay in accordance with the claimed invention includes a coil, a first contact terminal, a second contact terminal, a coil terminal, and a spool. The first contact terminal is disposed in front of the coil. The second contact terminal is disposed behind the coil. The coil terminal includes a body portion and a tie-down portion. The body portion is disposed between the first contact terminal and the second contact terminal. The tie-down portion extends forward from the body portion along the coil. The coil is wound around the spool, with an end of the coil being connected to the tie-down portion to electrically connect the coil to the coil terminal. The spool is disposed between the first contact terminal and the second contact terminal. The spool includes a front flange and a rear flange. The front flange faces the first contact terminal. The rear flange faces the second contact terminal. The front flange includes a vertical wall portion and a lateral wall portion. The vertical wall portion is located between the first contact terminal and the tie-down portion. The lateral wall portion is bent relative to the vertical wall portion and extends forward from the vertical wall portion.

In an embodiment of the electromagnetic relay, the tie-down portion of the coil terminal extends forward from the body portion along the coil. Therefore, the coil terminal is arranged compactly together with the coil. Additionally, the vertical wall portion of the front flange is located between the first contact terminal and the tie-down portion. Therefore, the insulation distance between the first contact terminal and the tie-down portion becomes longer. Additionally, the lateral wall portion of the front flange extends forward from the vertical wall portion. Therefore, the insulation distance between the first contact terminal and the tie-down portion is further increased. This improves the insulation between the first contact terminal and the coil terminal.

The spool may include a central flange disposed between the front and rear flanges. The first contact terminal may be attached to the front flange. The second contact terminal may be attached to the rear flange. The coil terminal may be attached to the central flange. In this case, the first contact terminal, the second contact terminal, and the coil terminal are all attached to the spool. Therefore, the positional accuracy of the first contact terminal, the second contact terminal, and the coil terminal is improved. This provides a stable insulation distance between the first contact terminal and the coil terminal.

The lateral wall portion may extend forward from the vertical wall portion to a position beyond the first contact terminal. In this case, the insulation distance between the first contact terminal and the tie-down portion becomes longer. This improves the insulation between the first contact terminal and the coil terminal. The lateral wall portion may cover the first contact terminal from a lateral side. In this case, the insulation distance between the first contact terminal and the tie-down portion becomes longer. This improves the insulation between the first contact terminal and the coil terminal.

The spool may include a support portion. The support portion may be provided on the front flange and may support the first contact terminal. The lateral wall portion may extend downward from the support portion. In this case, the rigidity of the support portion is improved by the lateral wall portion. This allows the first contact terminal to be stably supported by the support portion. The support portion may be longer than the lateral wall portion in the front-rear direction. In this case, the first contact terminal can be supported more stably by the support portion.

The electromagnetic relay may further include a first contact, a third contact terminal, a third contact, a movable piece, and a movable contact. The first contact may be provided on the first contact terminal. The third contact terminal may be disposed in front of the first contact terminal. The third contact may be provided on the third contact terminal. The movable piece may be connected to the second contact terminal. The movable contact may be provided on the movable piece and disposed between the first contact and the third contact. In this case, the first contact, the movable contact, and the third contact are arranged side-by-side in the front-rear direction. Therefore, in order to prevent the electromagnetic relay from becoming large in size in the front-rear direction, it is difficult to increase the distance between the tie-down portion and the first contact terminal. However, in the disclosed embodiment of an electromagnetic relay, even if the distance between the tie-down portion and the first contact terminal is small, the vertical wall portion and the lateral wall portion improve the insulation between the tie-down portion and the first contact terminal.

The electromagnetic relay may further include a base disposed below the spool. The base may include a base wall portion disposed between the first contact terminal and the tie-down portion. In this case, the base wall portion further increases the insulation distance between the first contact terminal and the tie-down portion. This improves the insulation between the first contact terminal and the coil terminal.

The electromagnetic relay may further include a base and a case. The base may be disposed below the spool. The case may be attached to the base and cover the spool. The case may include a case wall portion disposed between the first contact terminal and the tie-down portion. In this case, the case wall portion further increases the insulation distance between the first contact terminal and the tie-down portion. This improves the insulation between the first contact terminal and the coil terminal.

The electromagnetic relay may further include a third contact terminal and a case. The third contact terminal may be disposed in front of the first contact terminal. The case may include a side surface that laterally covers the first contact terminal and the third contact terminal. The lateral wall portion may be disposed between the first contact terminal and the side surface of the case. A front end of the lateral wall portion may be located between the first contact terminal and the third contact terminal. In this case, the creepage distance between the first contact terminal and the third contact terminal is increased by the thickness of the lateral wall portion. This improves the insulation between the first contact terminal and the third contact terminal.

### BRIEF DESCRIPTION OF THE DRAWINGS

FIG. 1 is a perspective view of an embodiment of an electromagnetic relay in accordance with the claimed invention.

FIG. 2 is a perspective view of the electromagnetic relay in accordance with the claimed invention.

FIG. 3 is a side view of the electromagnetic relay.

FIG. 4 is a perspective view of the electromagnetic relay with a common terminal, a movable piece, and an armature omitted.

FIG. 5 is an exploded perspective view of a spool and a base.

FIG. 6 is a perspective view of a first fixed terminal.

FIG. 7 is a perspective view of the electromagnetic relay from below, with the common terminal, the movable piece, and the armature omitted.

FIG. 8 is a perspective view of a second fixed terminal.

FIG. 9 is a side view of the electromagnetic relay.

FIG. 10 is a cross-sectional top view of the electromagnetic relay.

FIG. 11 is an enlarged view of a portion of FIG. 10.

FIG. 12 is a side view of the electromagnetic relay.

FIG. 13 is a side view of an electromagnetic relay according to a first exemplary modified embodiment.

FIG. 14 is a cross-sectional side view of an electromagnetic relay according to a second exemplary modified embodiment.

FIG. 15 is a perspective view of a base of the electromagnetic relay according to the second exemplary modified embodiment.

FIG. 16 is a sectional top view of an electromagnetic relay according to a third exemplary modified embodiment.

FIG. 17 is a side view of an electromagnetic relay according to a fourth exemplary modified embodiment.

FIG. 18 is a sectional top view of an electromagnetic relay according to a fifth exemplary modified embodiment.

### DETAILED DESCRIPTION

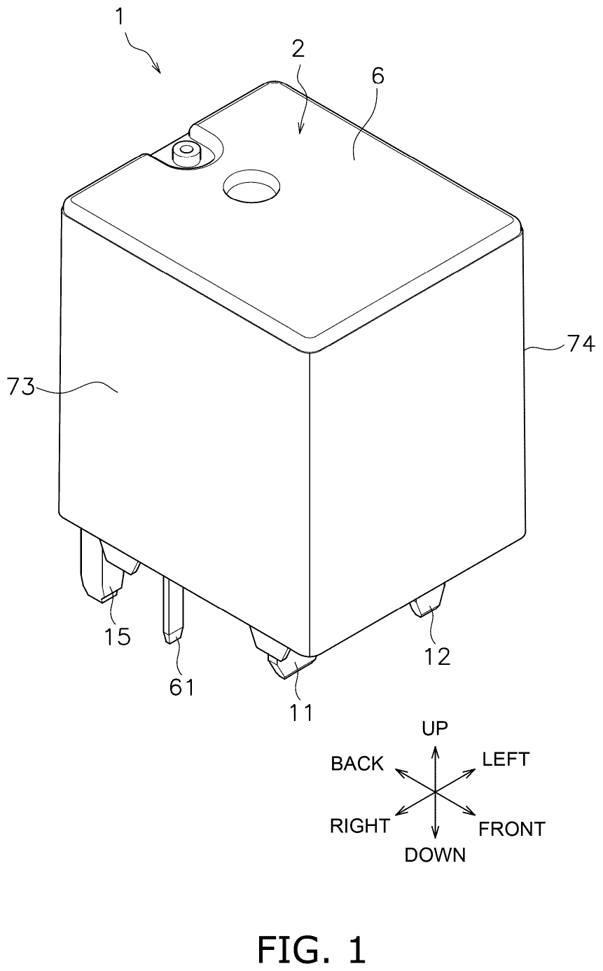

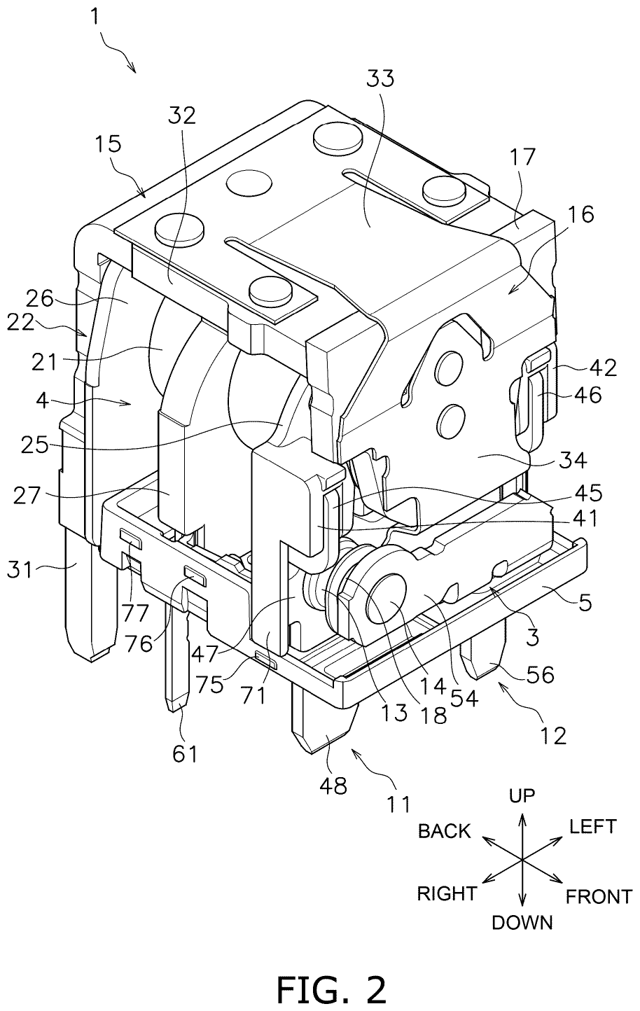

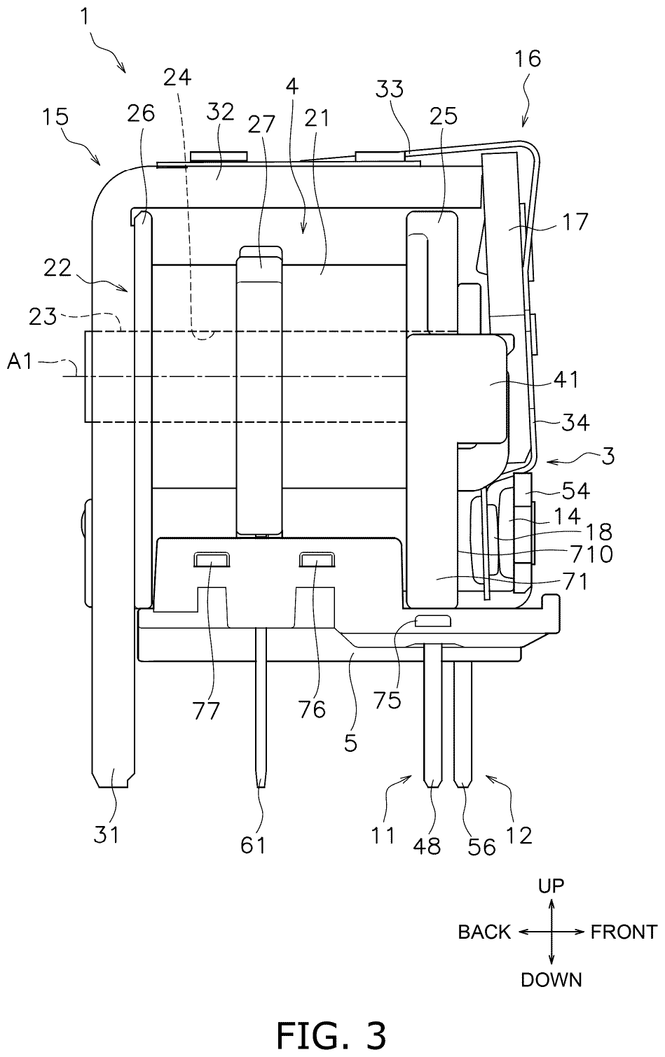

Hereinafter, an embodiment of an electromagnetic relay in accordance with the claimed invention will be described with reference to the drawings. FIGS. 1 and 2 are perspective views of the embodiment of an electromagnetic relay 1 in accordance with the claimed invention. FIG. 3 is a side view of the electromagnetic relay 1. As shown in FIGS. 1 to 3, the electromagnetic relay 1 includes a housing 2, a contact device 3, and a drive device 4. The contact device 3 and the drive device 4 are disposed within the housing 2.

The housing 2 includes a base 5 and a case 6. The base 5 supports the drive device 4. The case 6 is attached to the base 5 and covers the drive device 4 and the contact device 3. The base 5 and the case 6 are made of an insulating material such as resin. Alternatively, the base 5 and case 6 may be made of other insulating materials, such as ceramic. It should be noted that the case 6 is omitted in FIGS. 2 and 3.

The contact device 3 includes a first fixed terminal 11, a second fixed terminal 12, a first fixed contact 13, a second fixed contact 14, a common terminal 31, a movable piece 16, an armature 17, and a movable contact 18. The first fixed terminal 11, the second fixed terminal 12, the first fixed contact 13, the second fixed contact 14, the movable contact 18, the common terminal 31, and the movable piece 16 are made of a conductive metal. The armature 17 is made of a magnetic material.

In the following description, the direction in which the second fixed contact 14 is disposed relative to the first fixed contact 13 is defined as the “front”, and the opposite direction is defined as the “rear”. The direction in which the contact device 3 and the drive device 4 are disposed with respect to the base 5 is defined as “upper”, and the opposite direction is defined as “lower”. Additionally, the left and right directions facing forward are defined as “left” and “right”, respectively. However, these directions are defined for the convenience of explanation and do not limit the direction in which the electromagnetic relay 1 is used.

The drive device 4 operates the contact device 3 by electromagnetic force. The drive device 4 includes a coil 21, a spool 22, a yoke 15, and an iron core 23. The coil 21 is wound around the spool 22. The spool 22 is supported by the base 5. As shown in FIG. 3, the spool 22 and the coil 21 are disposed so that the central axis A1 of the coil 21 faces the front-rear direction. The spool 22 includes a hole 24. The hole 24 extends in the front-rear direction. The iron core 23 is disposed within a hole 24 in the spool 22. The iron core 23 is connected to the yoke 15.

The spool 22 is made of an insulating material such as resin. The spool 22 includes a first flange 25, a second flange 26, and a central flange 27. The first flange 25, the second flange 26, and the central flange 27 protrude in the radial direction of the coil 21. The first flange 25 is located at the front end of the spool 22. The second flange 26 is located at the rear end of the spool 22. The central flange 27 is disposed between the first flange 25 and the second flange 26 in the front-rear direction. The first flange 25 faces the first fixed terminal 11. The second flange 26 faces the common terminal 31. The central flange 27 is disposed between the first fixed terminal 11 and the common terminal 31.

A portion of the first fixed terminal 11 protrudes from the base 5 to the exterior of the electromagnetic relay 1. The first fixed terminal 11 is supported by the spool 22. The first fixed terminal 11 is disposed in front of the coil 21. The first fixed terminal 11 is disposed in front of the first flange 25. The first fixed terminal 11 is attached to the first flange 25. The first fixed contact 13 is provided on the first fixed terminal 11.

A portion of the second fixed terminal 12 protrudes from the base 5 to the exterior of the electromagnetic relay 1. The second fixed terminal 12 is supported by the spool 22. The second fixed terminal 12 is disposed in front of the coil 21. The second fixed terminal 12 is disposed in front of the first fixed terminal 11. The second fixed terminal 12 is attached to the central flange 27. The second fixed contact 14 is provided on the second fixed terminal 12.

A portion of the common terminal 31 protrudes from the base 5 to the exterior of the electromagnetic relay 1. The common terminal 31 is integrated with the yoke 15. The common terminal 31 is supported by the spool 22 via the yoke 15. The common terminal 31 is disposed behind the coil 21. The common terminal 31 is disposed behind the second flange 26. The common terminal 31 is attached to the second flange 26 via the yoke 15.

The common terminal 31 extends in the vertical direction. The lower end of the common terminal 31 protrudes downward from the base 5. The yoke 15 extends upward from the common terminal 31 and has an L-shaped bent shape. The yoke 15 includes a horizontal portion 32. The horizontal portion 32 extends in the front-rear direction. The horizontal portion 32 is disposed above the spool 22. The horizontal portion 32 is disposed above the first flange 25, the second flange 26, and the central flange 27.

The movable piece 16 is connected to the common terminal 31 via the yoke 15. The movable contact 18 is provided on the movable piece 16. The movable piece 16 has a spring property. The movable piece 16 includes a leaf spring portion 33 and a movable support portion 34. The movable piece 16 has a bent shape between the leaf spring portion 33 and the movable support portion 34. The leaf spring portion 33 is disposed above the horizontal portion 32 of the yoke 15. The leaf spring portion 33 is fixed to the horizontal portion 32. The movable support portion 34 is disposed in front of the spool 22. The movable support portion 34 extends in the vertical direction. The lower portion of the movable support portion 34 is disposed between the first fixed terminal 11 and the second fixed terminal 12. The movable contact 18 is provided at the lower portion of the movable support portion 34. The movable contact 18 is disposed between the first fixed terminal 11 and the second fixed terminal 12 in the front-rear direction.

The armature 17 is attached to the movable piece 16. The armature 17 is disposed in front of the spool 22. The armature 17 is disposed between the movable support portion 34 of the movable piece 16 and the iron core 23. The armature 17 is attached to the movable support portion 34. The upper portion of the armature 17 is in contact with the horizontal portion 32 of the yoke 15.

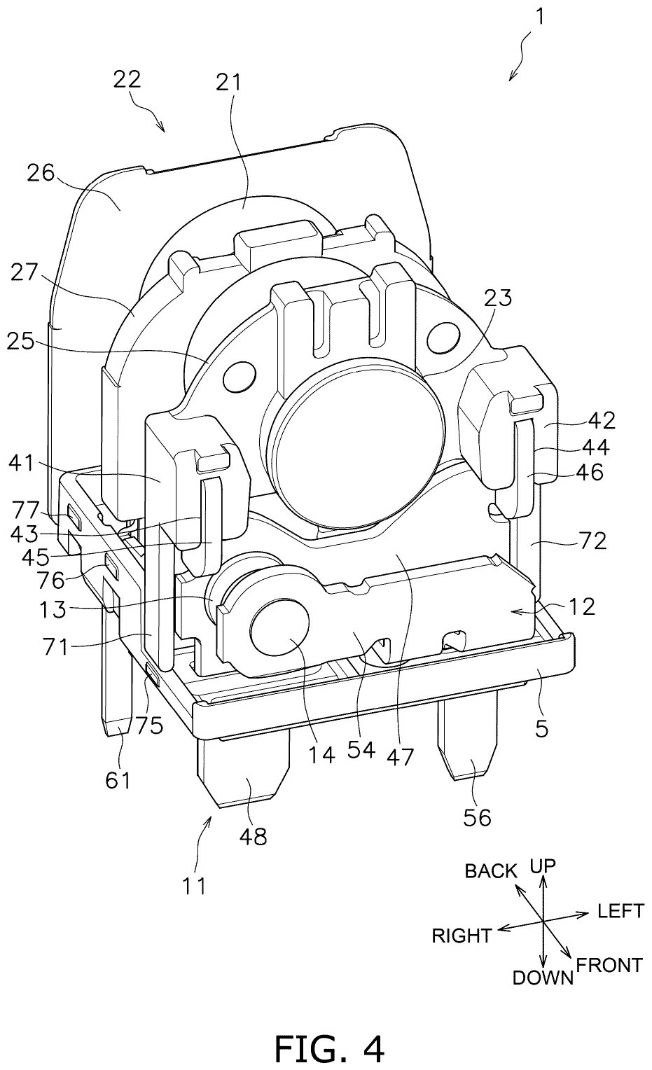

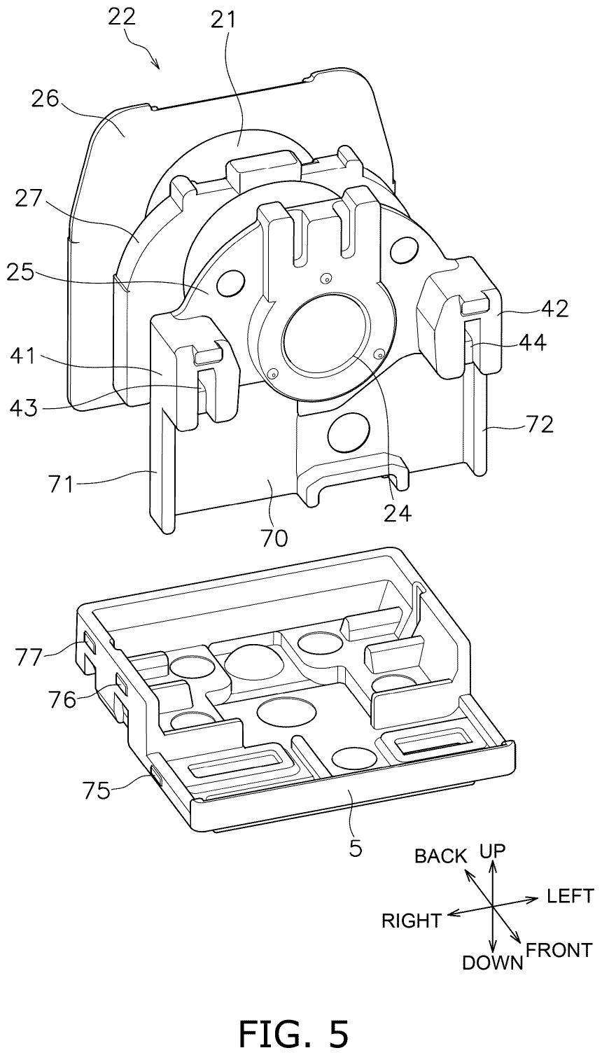

FIG. 4 is a perspective view of the electromagnetic relay 1 with the case 6, the yoke 15, the movable piece 16, and the armature 17 omitted. FIG. 5 is an exploded perspective view of the spool 22 and the base 5. As shown in FIGS. 4 and 5, the spool 22 includes a first support portion 41 and a second support portion 42. The first support portion 41 is provided on the first flange 25. The first support portion 41 and the second support portion 42 are formed integrally with the first flange 25. The first support portion 41 and the second support portion 42 support the first fixed terminal 11.

The first support portion 41 protrudes forward from the first flange 25. The first support portion 41 is disposed to the right of the hole 24 of the spool 22. The first support portion 41 supports the first fixed terminal 11. The first support portion 41 is located at the same height as the central axis A1 of the coil 21. The upper end of the first support portion 41 is located above the central axis A1 of the coil 21. The first support portion 41 includes a first groove 43. The first groove 43 extends in the up-down direction in the first support portion 41.

The second support portion 42 is disposed apart from the first support portion 41 in the left-right direction. The second support portion 42 is provided on the first flange 25. The second support portion 42 protrudes forward from the first flange 25. The second support portion 42 is disposed to the left of the hole 24 of the spool 22. The second support portion 42 supports the first fixed terminal 11. The second support portion 42 is located at the same height as the central axis A1 of the coil 21. The upper end of the second support portion 42 is located above the central axis A1 of the coil 21. The second support portion 42 includes a second groove 44. The second groove 44 extends in the up-down direction in the second support portion 42.

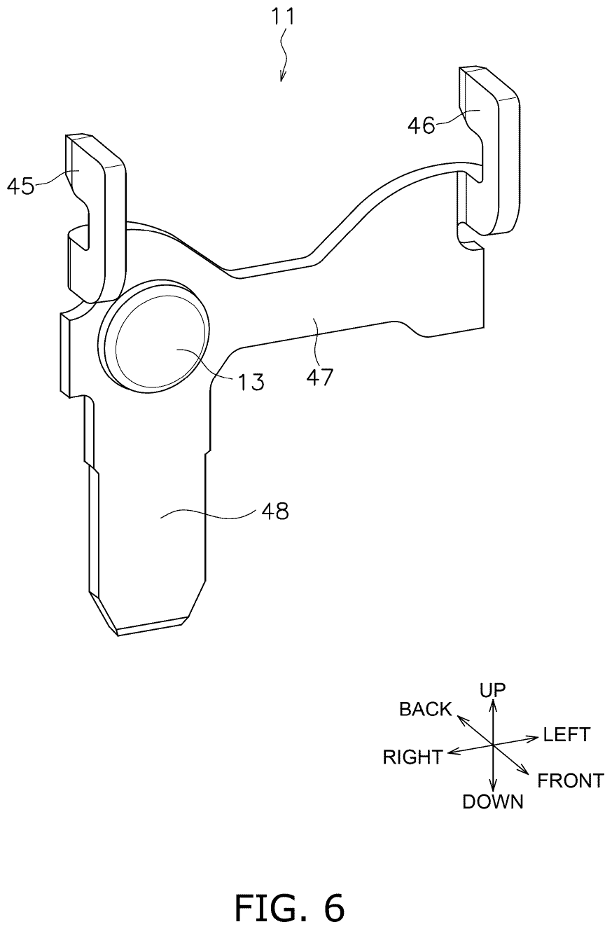

FIG. 6 is a perspective view of the first fixed terminal 11. As shown in FIG. 6, the first fixed terminal 11 includes a first locking portion 45, a second locking portion 46, a first contact support portion 47, and a first external terminal portion 48. The first locking portion 45 extends in the front-rear direction and the up-down direction. The first locking portion 45 is press-fitted into the first groove 43. Thereby, the first fixed terminal 11 is attached to the first support portion 41. The second locking portion 46 extends in the front-rear direction and the up-down direction. The second locking portion 46 is press-fitted into the second groove 44. Thereby, the first fixed terminal 11 is attached to the second support portion 42.

The first contact support portion 47 extends in the left-right direction. The first contact support portion 47 connects the first locking portion 45 and the second locking portion 46. The first fixed contact 13 is provided on the first contact support portion 47. The first external terminal portion 48 extends downward from the first contact support portion 47. The first external terminal portion 48 protrudes from the base 5 to the exterior of the electromagnetic relay 1.

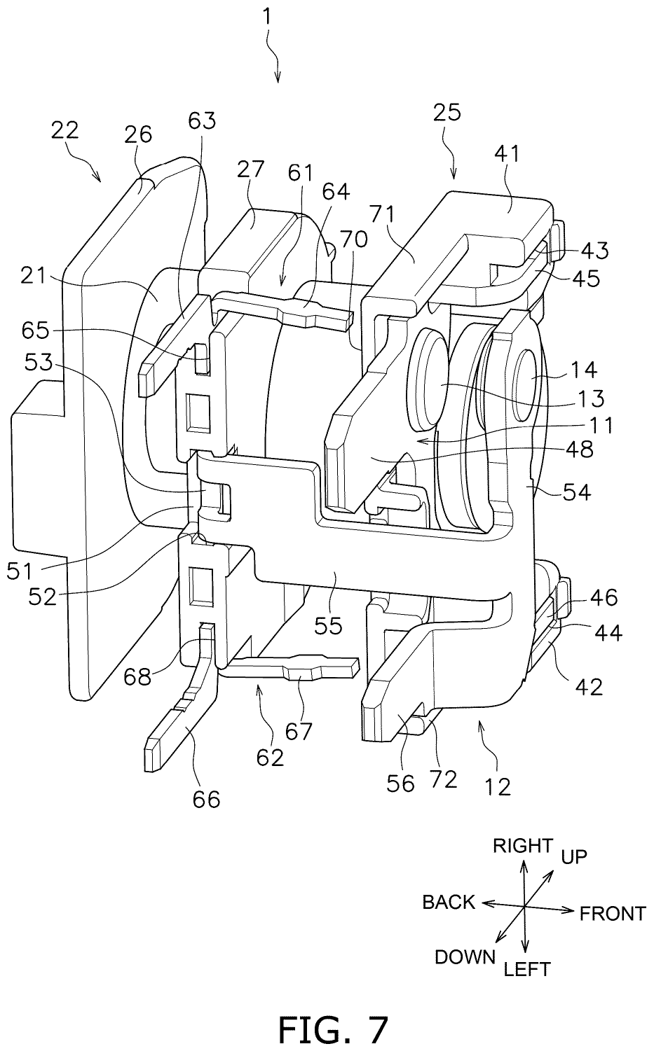

FIG. 7 is a perspective view of the electromagnetic relay 1 from below, with the housing 2, the yoke 15, the movable piece 16, and the armature 17 omitted. As shown in FIG. 7, the spool 22 includes a third support portion 51. The third support portion 51 is provided on the central flange 27. The third support portion 51 supports the second fixed terminal 12. The third support portion 51 includes a third groove 52. The third groove 52 is provided on the bottom surface of the central flange 27.

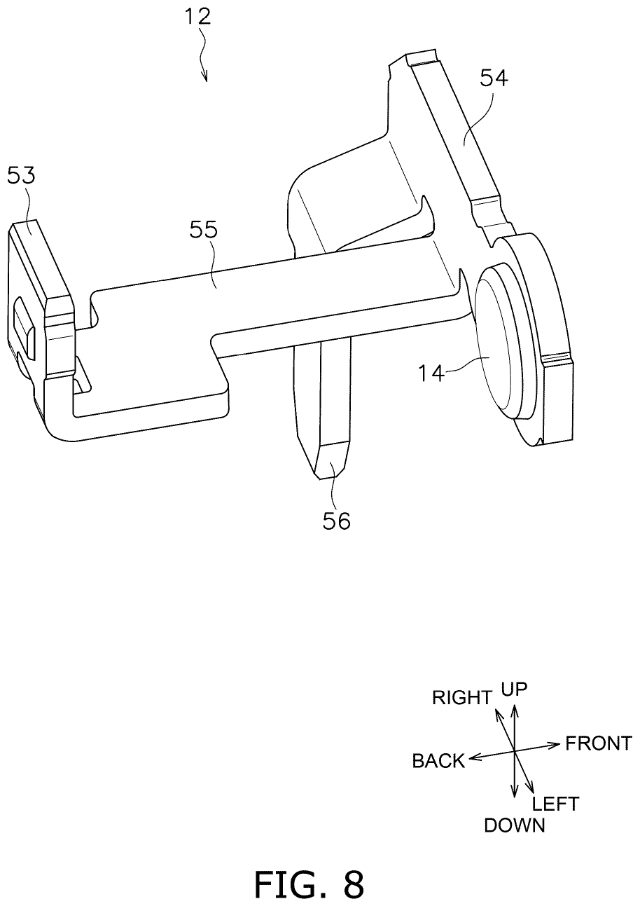

FIG. 8 is a perspective view of the second fixed terminal 12. As shown in FIG. 8, the second fixed terminal 12 includes a third locking portion 53, a second contact support portion 54, a connecting portion 55, and a second external terminal portion 56. The third locking portion 53 extends in the up-down direction. The third locking portion 53 is press-fitted into the third groove 52. Thereby, the second fixed terminal 12 is attached to the third support portion 51. The second contact support portion 54 extends in the left-right direction. The second fixed contact 14 is provided on the second contact support portion 54. The connecting portion 55 extends in the front-rear direction. The connecting portion 55 connects the third locking portion 53 and the second contact support portion 54 together. The second external terminal portion 56 extends downward from the second contact support portion 54. The second external terminal portion 56 protrudes from the base 5 to the exterior of the electromagnetic relay 1.

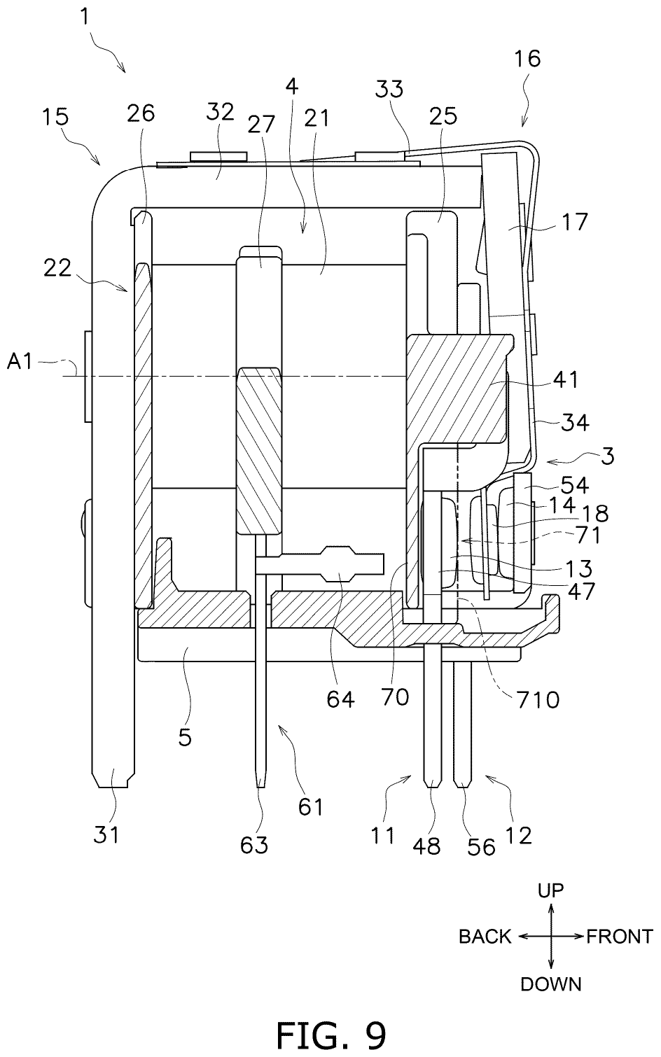

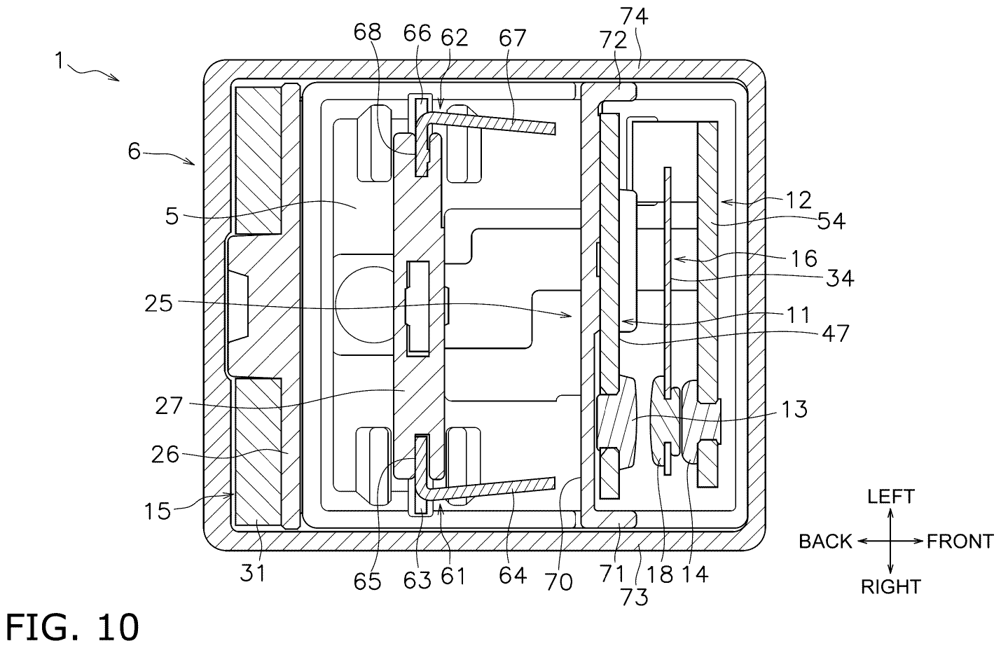

FIG. 9 is a side view of the electromagnetic relay 1. In FIG. 9, a part of the spool 22 is shown in cross section. FIG. 10 is a cross-sectional top view of the electromagnetic relay 1. As shown in FIGS. 9 and 10, the electromagnetic relay 1 includes a first coil terminal 61 and a second coil terminal 62. The first coil terminal 61 and the second coil terminal 62 are connected to the coil 21. The first coil terminal 61 and the second coil terminal 62 are attached to the central flange 27. The first coil terminal 61 and the second coil terminal 62 are disposed between the first fixed terminal 11 and the common terminal 31. It should be noted that case 6 is omitted in FIG. 9.

As shown in FIG. 9, the first coil terminal 61 includes a first body portion 63 and a first tie-down portion 64. The first body portion 63 is supported by the central flange 27. The first body portion 63 extends downward from the central flange 27. The first body portion 63 protrudes from the base 5 to the exterior of the electromagnetic relay 1.

The first tie-down portion 64 is formed integrally with the first body portion 63. The first tie-down portion 64 is bent relative to the first body portion 63. The first tie-down portion 64 extends forward from the first body portion 63 along the axial direction of the coil 21. The first tie-down portion 64 extends from the first body portion 63 toward the first flange 25. The first tie-down portion 64 extends from the first body portion 63 toward the first fixed terminal 11. A first end of the coil 21 is wound around the first tie-down portion 64 to secure and electrically connect that end of the coil 21 to the first coil terminal 61.

The second coil terminal 62 has a similar shape to the first coil terminal 61. The second coil terminal 62 is disposed away from the first coil terminal 61 in the left-right direction. The second coil terminal 62 includes a second body portion 66 and a second tie-down portion 67. The second body portion 66 and the second tie-down portion 67 have the same shapes as the first body portion 63 and the first tie-down portion 64, respectively. A second end of the coil 21 is wound around the second tie-down portion 67 to secure and electrically connect that second end of the coil 21 to the second coil terminal 62.

As shown in FIG. 10, the central flange 27 includes a fourth groove 65 and a fifth groove 68. The fourth groove 65 and the fifth groove 68 are disposed to the left and right of the third groove 52. The first body portion 63 is press-fitted into the fourth groove 65. The first coil terminal 61 is thereby attached to the central flange 27. The second body portion 66 is press-fitted into the fifth groove 68. The second coil terminal 62 is thereby attached to the central flange 27.

As shown in FIG. 5, the first flange 25 includes a vertical wall portion 70, a first lateral wall portion 71, and a second lateral wall portion 72. The vertical wall portion 70 extends in the left-right direction. The vertical wall portion 70 extends upward from the base 5. The vertical wall portion 70 is disposed behind the first fixed terminal 11. The vertical wall portion 70 is disposed between the first fixed terminal 11 and the first tie-down portion 64. The vertical wall portion 70 is disposed between the first fixed terminal 11 and the second tie-down portion 67.

The first lateral wall portion 71 is bent relative to the vertical wall portion 70. The first lateral wall portion 71 is disposed laterally outward of the first contact support portion 47 of the first fixed terminal 11. The first lateral wall portion 71 covers the first contact support portion 47 from the laterally outer side. In a side view, the first lateral wall portion 71 overlaps with the first contact support portion 47. The first lateral wall portion 71 is disposed laterally outward of the first fixed contact 13. The first lateral wall portion 71 covers the first fixed contact 13 from the laterally outer side. In a side view, the first lateral wall portion 71 overlaps the first fixed contact 13. The first lateral wall portion 71 is disposed at a non-overlapping position with the second contact support portion 54 in a side view. The first lateral wall portion 71 is disposed at a non-overlapping position with the second fixed contact 14 in a side view.

The first lateral wall portion 71 extends forward from the vertical wall portion 70. In FIG. 9, the two-dot chain line indicates the position of the front end 710 of the first lateral wall portion 71. As shown in FIGS. 9 and 10, the first lateral wall portion 71 extends forward from the vertical wall portion 70 to a position beyond the first fixed terminal 11. The front end 710 of the first lateral wall portion 71 is located between the first fixed terminal 11 and the second fixed terminal 12. The front end 710 of the first lateral wall portion 71 is located between the first fixed contact 13 and the second fixed 10) contact 14. The position between first fixed contact 13 and second fixed contact 14 is a position from a position aligned with the contact surface of first fixed contact 13 to a position aligned with the contact surface of second fixed contact 14 in a side view. In the present embodiment, the front end 710 of the first lateral wall portion 71 is located in a position aligned with the contact surface of the first fixed contact 13 in a side view.

As shown in FIG. 3, the first lateral wall portion 71 extends downward from the first support portion 41. The first lateral wall portion 71 is shorter than the first support portion 41 in the front-rear direction. That is, the first support portion 41 is longer than the first lateral wall portion 71 in the front-rear direction.

As shown in FIG. 10, the case 6 includes a first side surface 73 and a second side surface 74. The first side surface 73 and the second side surface 74 are disposed apart from each other in the left-right direction. The first side surface 73 covers the first fixed terminal 11 and the second fixed terminal 12 from the right side. The second side surface 74 covers the first fixed terminal 11 and the second fixed terminal 12 from the left side. The first lateral wall portion 71 is disposed between the first fixed terminal 11 and the first side surface 73. In particular, the first lateral wall portion 71 is disposed between the first contact support portion 47 and the first side surface 73 of the first fixed terminal 11.

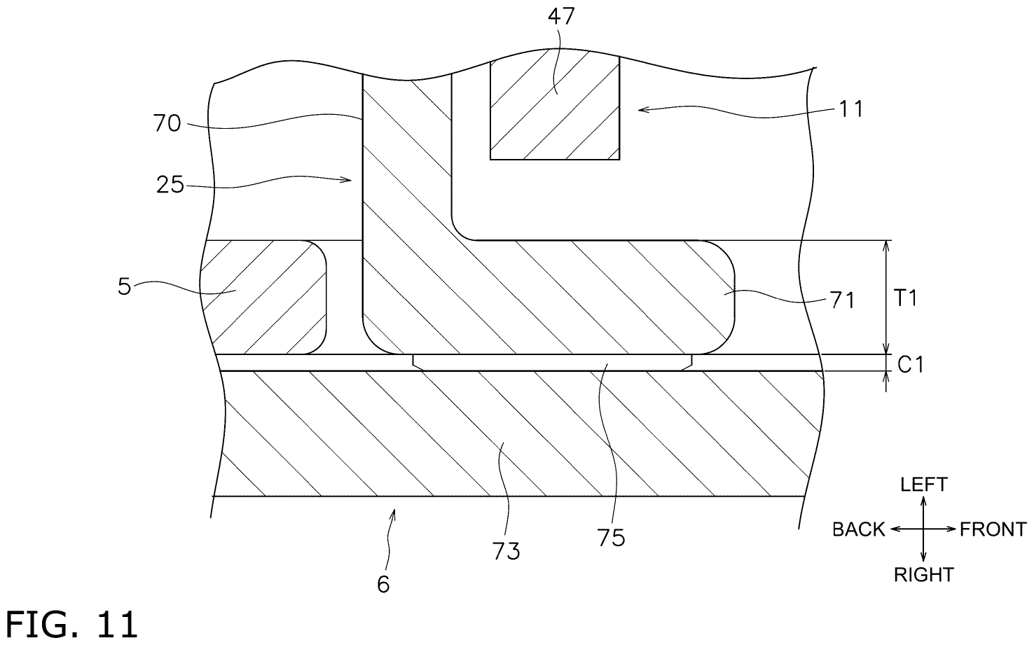

FIG. 11 is an enlarged view of a portion of FIG. 10. As shown in FIG. 11, a clearance C1 is provided between the first side surface 73 of the case 6 and the first lateral wall portion 71. As shown in FIG. 2, projections 75 to 77 are provided on a side surface of the base 5. As shown in FIG. 11, the projections 75 to 77 come into contact with the first side surface 73, thereby providing the clearance C1 between the first side surface 73 and the first lateral wall portion 71.

The second lateral wall portion 72 has the same shape as the first lateral wall portion 71. The second lateral wall portion 72 is disposed symmetrically to the first lateral wall portion 71. Although not shown, a clearance is provided between the second side surface 74 and the second lateral wall portion 72, similar to the first side surface 73 and the first lateral wall portion 71.

The vertical wall portion 70 and the first lateral wall portion 71 described above increase the insulation distance between the first coil terminal 61 and the first fixed terminal 11. In addition, the vertical wall portion 70 and the second lateral wall portion 72 provide an insulation distance between the second coil terminal 62 and the first fixed terminal 11.

In the electromagnetic relay 1 described above, the electromagnetic relay 1 operates when electricity is applied to the coil 21 via the first coil terminal 61 and the second coil terminal 62. The operation of the electromagnetic relay 1 will now be described.

In the electromagnetic relay 1, when the coil 21 is not energized, as shown in FIG. 9, the elastic force of the contact piece keeps the armature 17 away from the iron core 23 and urges the movable contact 18 toward the second fixed contact 14. As a result, the movable contact 18 is separated from the first fixed contact 13 and is in contact with the second fixed contact 14.

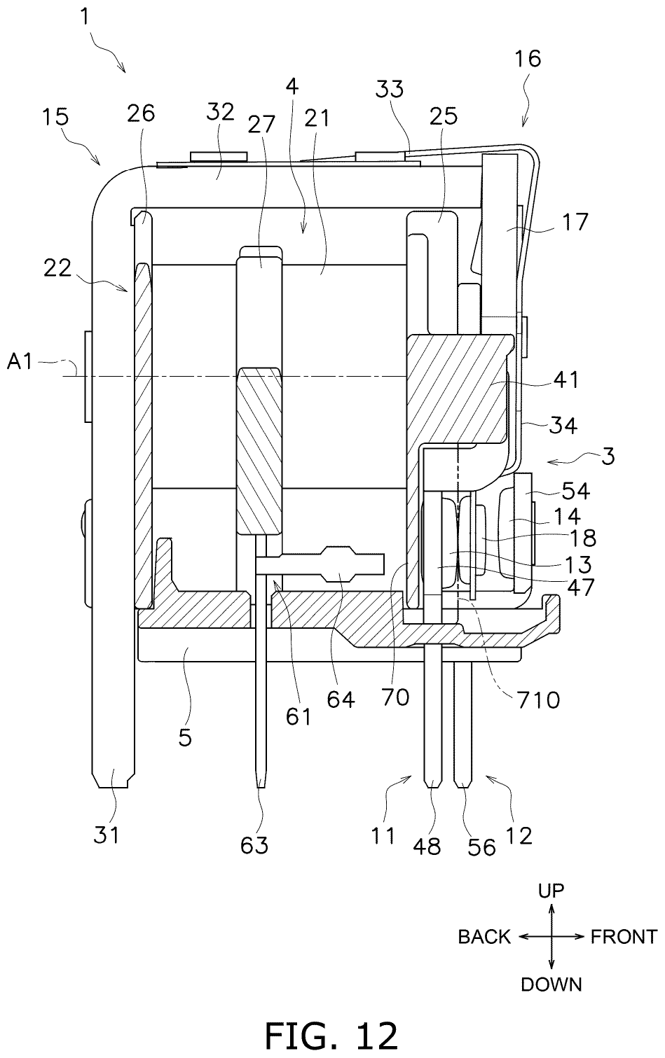

When the coil 21 is energized, the magnetic field generated by the coil 21 generates a magnetic force, which attracts the armature 17 to the iron core 23. This causes the movable piece 16 to deform elastically, and the movable support portion 34 moves toward the first fixed terminal 11. As a result, as shown in FIG. 12, the movable contact 18 moves away from the second fixed contact 14 and comes into contact with the first fixed contact 13.

When the current supply to the coil 21 is turned off, the elastic force of the movable piece 16 causes the movable support portion 34 to move toward the second fixed contact 14. As a result, the armature 17 moves away from the iron core 23. As a result, as shown in FIG. 9, the movable contact 18 moves away from the first fixed contact 13 and comes into contact with the second fixed contact 14.

In the electromagnetic relay 1 according to the embodiment described above, as shown in FIG. 9, in the first coil terminal 61, the first tie-down portion 64 extends forward from the first body portion 63 along the coil 21. Therefore, the first coil terminal 61 is disposed compactly together with the coil 21. Further, the vertical wall portion 70 of the first flange 25 is located between the first fixed terminal 11 and the first tie-down portion 64. Therefore, the insulation distance between the first fixed terminal 11 and the first tie-down portion 64 becomes longer. In addition, the first lateral wall portion 71 extends forward from the vertical wall portion 70. Therefore, the insulation distance between the first fixed terminal 11 and the first tie-down portion 64 becomes even longer. This improves the insulation between the first fixed terminal 11 and the first coil terminal 61. Similarly, the second lateral wall portion 72 increases the insulation distance between the first fixed terminal 11 and the second tie-down portion 67. This improves the insulation between the first fixed terminal 11 and the second coil terminal 62.

As shown in FIG. 11, in the electromagnetic relay 1, the creepage distance between the first fixed terminal 11 and the second fixed terminal 12 is longer by the thickness Tl of the first lateral wall portion 71. This improves the insulation between the first fixed terminal 11 and the second fixed terminal 12 while preventing the electromagnetic relay 1 from becoming too large. In addition, the creepage distance between the first fixed terminal 11 and the second fixed terminal 12 is increased by the clearance C1 between the first lateral wall portion 71 and the first side surface 73. This improves the insulation between the first fixed terminal 11 and the second fixed terminal 12.

Although one embodiment of the claimed invention has been described above, the claimed invention is not limited to the above-described embodiment, and various modifications are possible without departing from the scope of the claimed invention.

The shapes of the first fixed terminal 11, the second fixed terminal 12, and the common terminal 31 are not limited to those in the above-described embodiment, and may be modified. The shape of the movable piece 16 is not limited to that in the above-described embodiment and may be changed. The shape of the spool 22 is not limited to that in the above embodiment and may be modified. For example, the second fixed terminal 12 may be supported by the first flange 25. The second fixed contact 14 of the second fixed terminal 12 may be omitted. In that case, the second external terminal portion 56 may be omitted, and the second fixed terminal 12 may be used as a dummy terminal. The common terminal 31 may not be integrated with the yoke 15 but may be separate therefrom. The common terminal 31 may be integrated with the movable piece 16.

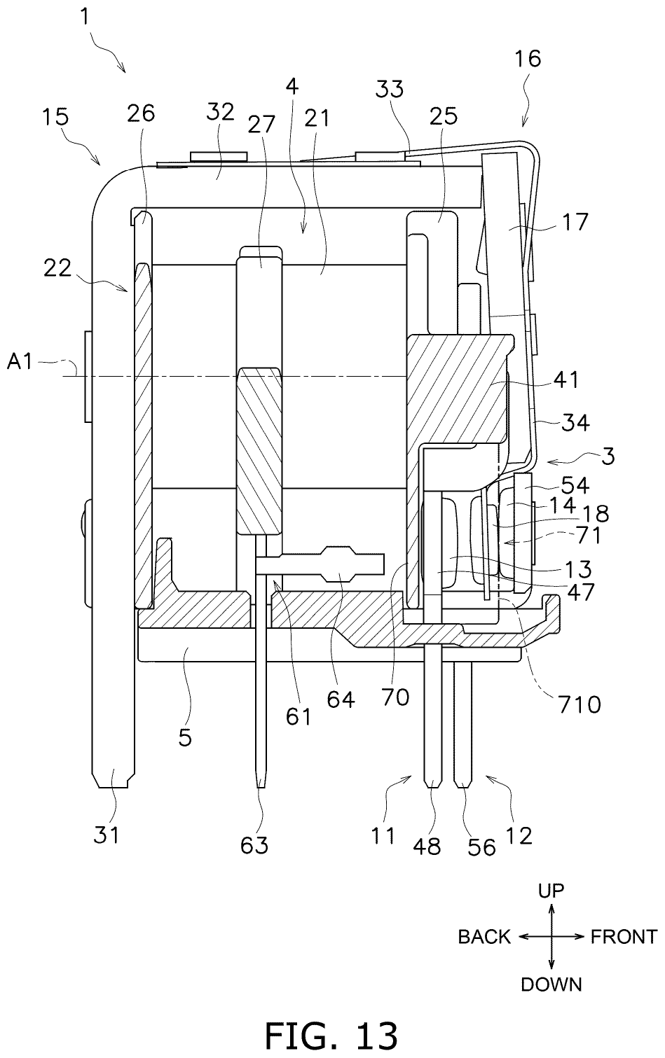

The shape of the first lateral wall portion 71 is not limited to that in the above embodiment and may be modified. For example, FIG. 13 is a side view of an electromagnetic relay 1 according to a first exemplary modified embodiment. As shown in FIG. 13, the first lateral wall portion 71 may extend to a position aligned with the contact surface of the second fixed contact 14. Alternatively, the first lateral wall portion 71 may extend between a position aligned with the contact surface of the first fixed contact 13 and a position aligned with the contact surface of the second fixed contact 14. The shape of the second lateral wall portion 72 may also be changed in the same manner as the first lateral wall portion 71.

The shapes of the base 5 and the case 6 are not limited to those in the above-described embodiment and may be modified. For example, the above-mentioned first side surface 73 may be provided on the base 5 instead of the case 6. That is, the first lateral wall portion 71 may be disposed between the first fixed terminal 11 and the side surface of the base 5 in the left-right direction. The second side surface 74 may also be provided on the base 5, similar to the first side surface 73. The above-mentioned projections 75 to 77 may be provided on the case 6 or the spool 22 instead of on the base 5.

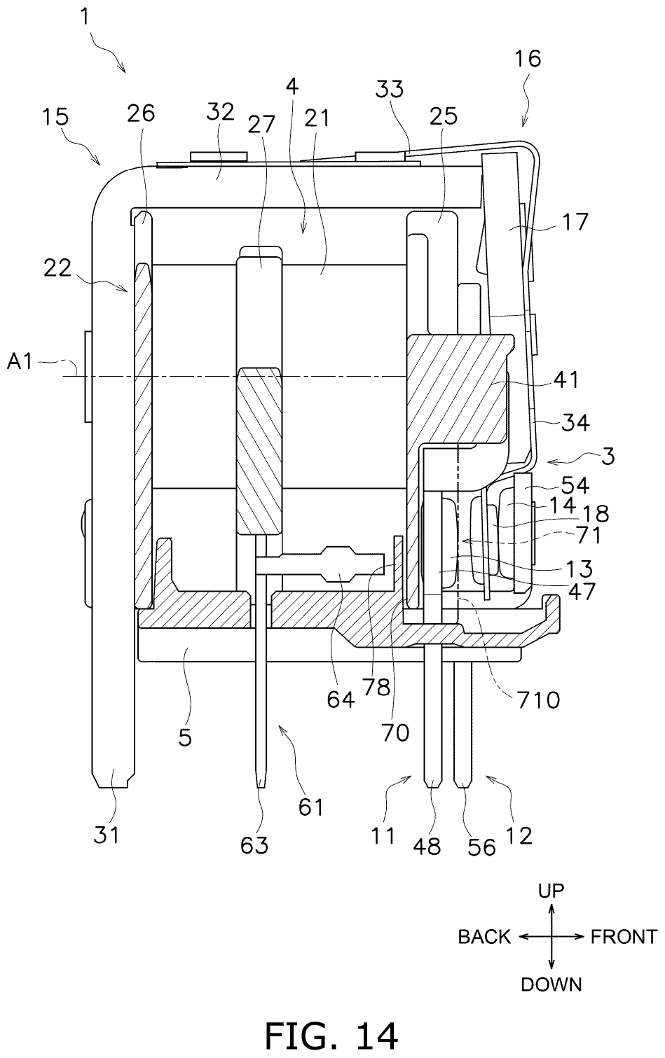

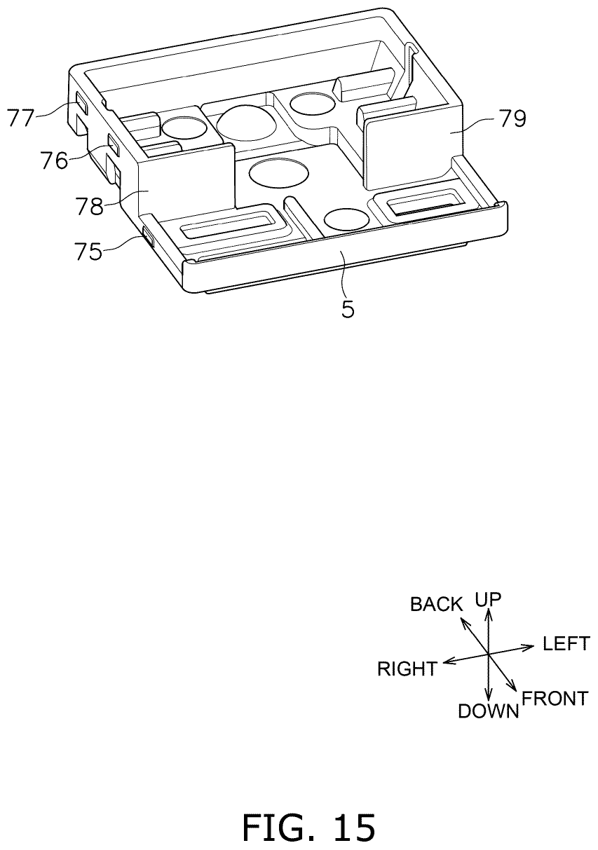

FIG. 14 is a cross-sectional side view of an electromagnetic relay 1 according to a second exemplary modified embodiment. FIG. 15 is a perspective view of the base 5 of the electromagnetic relay 1 according to the second exemplary modified embodiment. As shown in FIGS. 14 and 15, the base 5 may include a first base wall portion 78. The first base wall portion 78 may be disposed between the first fixed terminal 11 and the first tie-down portion 64. This further increases the insulation distance between the first coil terminal 61 and the first fixed terminal 11. The base 5 may include a second base wall portion 79. The second base wall portion 79 may be disposed between the first fixed terminal 11 and the second tie-down portion 67. This further increases the insulation distance between the second coil terminal 62 and the first fixed terminal 11.

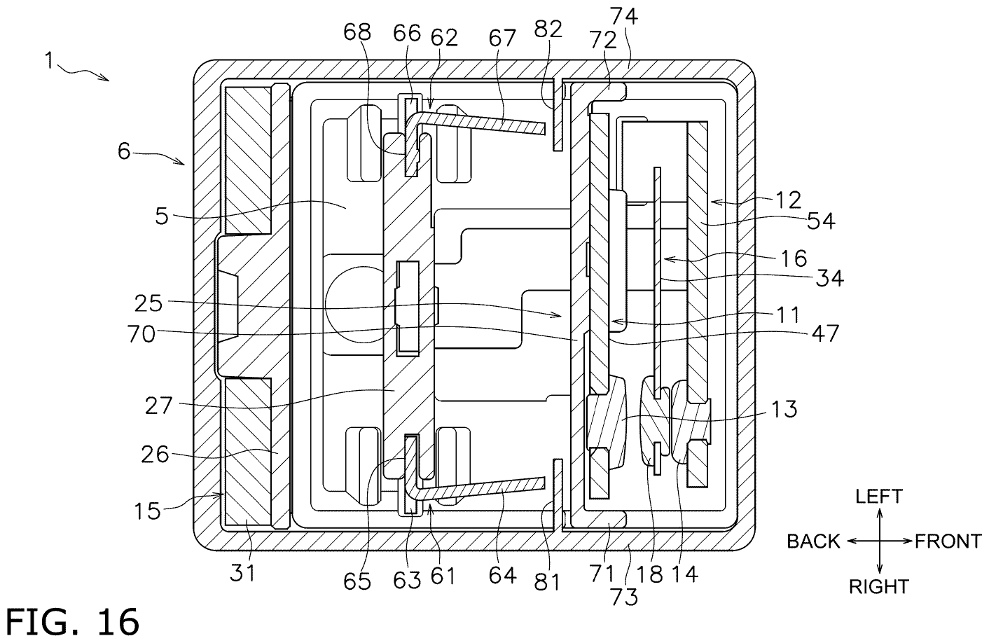

FIG. 16 is a sectional top view of an electromagnetic relay 1 according to a third exemplary modified embodiment. As shown in FIG. 16, the case 6 may include a first case wall portion 81. The first case wall portion 81 may be disposed between the first fixed terminal 11 and the first tie-down portion 64. This further increases the insulation distance between the first coil terminal 61 and the first fixed terminal 11. The case 6 may include a second case wall portion 82. The second case wall portion 82 may be disposed between the first fixed terminal 11 and the second tie-down portion 67. This further increases the insulation distance between the second coil terminal 62 and the first fixed terminal 11.

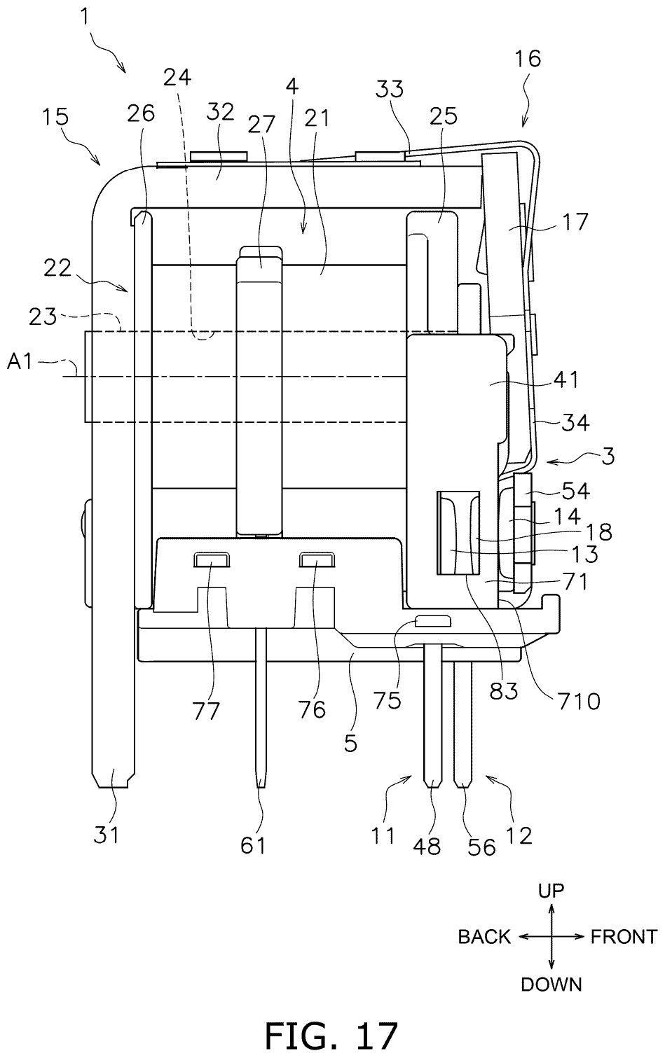

FIG. 17 is a side view of the electromagnetic relay 1 according to the fourth exemplary modified embodiment. As shown in FIG. 17, the first lateral wall portion 71 may include an opening 83. In this case, wear particles can escape through the opening 83. This suppresses deterioration of the insulation between the first fixed terminal 11 and the second fixed terminal 12 due to wear particles.

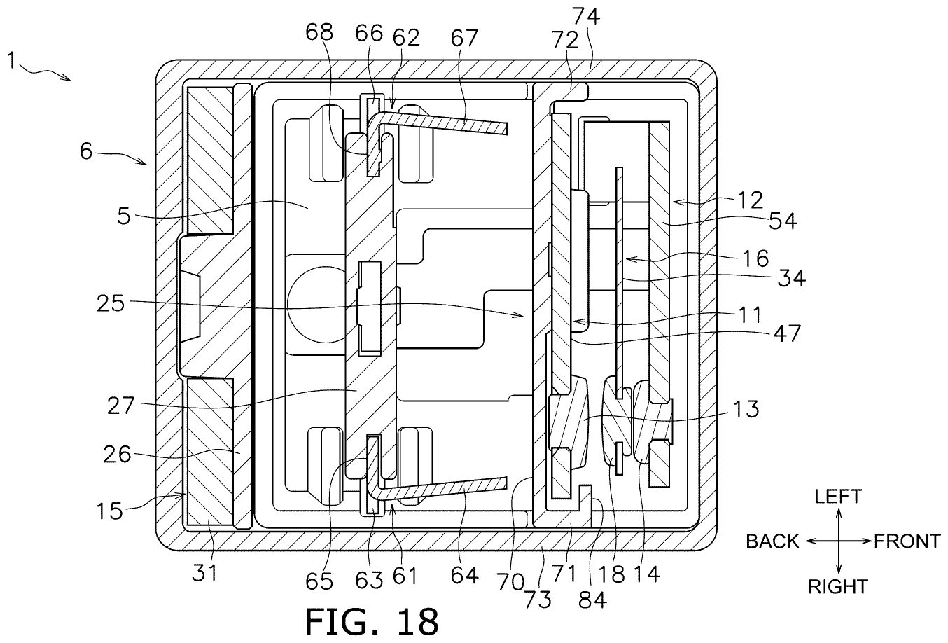

FIG. 18 is a side view of the electromagnetic relay 1 according to the fifth exemplary modified embodiment. As shown in FIG. 18, the spool 22 may include a bent portion 84. The bent portion 84 may protrude from the first lateral wall portion 71 toward a position between the first fixed terminal 11 and the second fixed terminal 12. In this case, the bent portion 84 prevents wear particles from scattering forward. This suppresses deterioration of the insulation between the first fixed terminal 11 and the second fixed terminal 12 caused by wear particles.

In the above-described embodiment, the first fixed terminal 11 corresponds to the first contact terminal of the present invention. The common terminal 31 corresponds to a second contact terminal of the present invention. The second fixed terminal 12 corresponds to a third contact terminal of the present invention. The first flange 25 corresponds to a front flange of the present invention. The second flange 26 corresponds to the rear flange of the present invention. However, the front-rear direction of the electromagnetic relay 1 may be opposite to that in the above embodiment. That is, the common terminal 31 may correspond to a first contact terminal of the present invention, and the first fixed terminal 11 may correspond to a second contact terminal of the present invention. The second flange 26 may correspond to a front flange of the present invention, and the first flange 25 may correspond to a rear flange of the present invention. The first tie-down portion 64 of the first coil terminal 61 may extend toward the common terminal 31. The first lateral wall portion 71 may be provided on the second flange 26. The second tie-down portion 67 of the second coil terminal 62 may extend toward the common terminal 31. The second lateral wall portion 72 may be provided on the second flange 26.

### REFERENCE SIGNS LIST

Base, 6: Case, 11: First fixed terminal, 12: Second fixed terminal, 13: First fixed contact, 14: Second fixed contact, 31: Common terminal, 16: Movable piece, 18: Movable contact, 21: Coil, 22: Spool, 25: First flange, 26: Second flange, 41: First support portion, 61: First coil terminal, 63: First body portion, 64: First tie-down portion, 70: Vertical wall portion, 71: First lateral wall portion, 78: First base wall portion, 81: First case wall portion

1. An electromagnetic relay, comprising:
a coil;
a first contact terminal disposed in front of the coil;
a second contact terminal disposed behind the coil;
a coil terminal including a body portion disposed between the first contact terminal and the second contact terminal, and a tie-down portion extending forward from the body portion along the coil; and
a spool around which the coil is wound with an end of the coil connected to the tie-down portion to electrically connect the coil to the coil terminal, the spool being disposed between the first contact terminal and the second contact terminal, the spool including a front flange facing the first contact terminal and a rear flange facing the second contact terminal,
wherein the front flange includes 1) a vertical wall portion located between the first contact terminal and the tie-down portion and 2) a lateral wall portion bent relative to the vertical wall portion and extending forward from the vertical wall portion.

2. The electromagnetic relay according to claim 1, wherein
the spool includes a central flange disposed between the front flange and the rear flange,
the first contact terminal is attached to the front flange,
the second contact terminal is attached to the rear flange, and
the coil terminal is attached to the central flange.

3. The electromagnetic relay according to claim 1, wherein the lateral wall portion extends forward from the vertical wall portion to a position beyond the first contact terminal.

4. The electromagnetic relay according to claim 1, wherein the lateral wall portion covers the first contact terminal from a lateral side.

5. The electromagnetic relay according to claim 1, wherein the spool includes a support portion that is provided on the front flange and supports the first contact terminal, and
the lateral wall portion extends downward from the support portion.

6. The electromagnetic relay according to claim 5, wherein the support portion is longer than the lateral wall portion in a front-rear direction of the electromagnetic relay.

7. The electromagnetic relay according to claim 1, further comprising
a first contact provided on the first contact terminal;
a third contact terminal disposed in front of the first contact terminal;
a third contact provided on the third contact terminal;
a movable piece connected to the second contact terminal; and
a movable contact provided on the movable piece and disposed between the first contact and the third contact.

8. The electromagnetic relay according to claim 1, further comprising a base disposed below the spool, the base including a base wall portion disposed between the first contact terminal and the tie-down portion.

9. The electromagnetic relay according to claim 1, further comprising
a base disposed below the spool; and
a case attached to the base and covering the spool, the case including a case wall portion disposed between the first contact terminal and the tie-down portion.

10. The electromagnetic relay according to claim 1, further comprising
a third contact terminal disposed in front of the first contact terminal; and
a case including a side surface covering the first contact terminal and the third contact terminal from a lateral side,
wherein the lateral wall portion is disposed between the first contact terminal and the side surface of the case, and
a front end of the lateral wall portion is located between the first contact terminal and the third contact terminal.
